(19) United States
(12) Patent Application Publication
(10) Pub. No.: US 2012/0287232 A1
(43) Pub. Date: Nov. 15, 2012

(54) Surround View System Camera Automatic Calibration

(75) Inventors: Koba Natroshvili, Waldbronn (DE); Bernd Gassmann, Straubenhardt (DE)

(73) Assignee: Harman Becker Automotive Systems GmbH, Karlsbad (DE)

(21) Appl. No.: 13/466,743

(22) Filed: May 8, 2012

(30) Foreign Application Priority Data
May 10, 2011 (EP) 11003828.8

(51) Int. Cl. H04N 17/00; H04N 7/18

(52) U.S. Cl. 348/36; 348/E07.085; 348/E17.002

(57) ABSTRACT

A system for calibrating a surround view system of an object, such as a vehicle. The system may be implemented via calibration logic that may include software, hardware, firmware, or a combination thereof. The system may include positioning a set of markers on a plane at least partially surrounding the object. The plane may be in a field of view of a camera of the surround view system, and the camera may include a predetermined intrinsic calibration. The system may also include determining a first plurality of extrinsic parameters of the camera with respect to the set of markers. The system may repeat the positioning of the set of markers and the determination of the first plurality of extrinsic parameters for at least one other camera of the surround view system.

### PRIORITY CLAIM

This application claims the benefit of priority from European Patent Application No. 11003828.3, filed May 10, 2011, which is incorporated by reference.

### BACKGROUND OF THE INVENTION

1. Technical Field

The present invention relates to calibration of a surround view system.

2. Related Art

In recent years, use of rear and side view cameras for vehicles has been proliferating. Often these cameras are used for driver assistance and can improve vehicle safety. Although, these cameras are known to provide views that typical rear and side view mirrors cannot, they too have blind spots that can be hazardous to the driver and others. In addition to blind spots, these cameras can also be hazardous in that the views that they provide often suggest to the driver of vehicle that there is more space between the vehicle and another object than in reality.

### SUMMARY

Described herein is a calibration system for calibrating a surround view system of an object, such as a vehicle. The calibration system may be implemented via calibration logic that may include software, hardware, firmware, or a combination thereof. The surround view system may have plurality of cameras, such as cameras having a fisheye lens. The calibration system may include positioning a set of markers on a plane at least partially surrounding the object. The plane may be in a field of view of a camera of the surround view system, and the camera may include a predetermined intrinsic calibration. The calibration system may also include determining a first plurality of extrinsic parameters of the camera with respect to the set of markers. The calibration system may repeat the positioning of the set of markers and the determination of the first plurality of extrinsic parameters for at least one other camera of the surround view system.

Further, the field of view of the camera may at least partially overlap the field of view of another camera of the surround view system. Given this, the calibration system may include selecting markers in an overlapping region of the field of views of a plurality of the cameras of the surround view system.

Also, the calibration system may include determining a second plurality of extrinsic parameters of the camera with respect to the set of markers and with respect to the first plurality of extrinsic parameters of the at least one other camera of the surround view system.

Also, the set of markers may include comprise an origin and the first plurality of extrinsic parameters may include a reference to the origin. Given this, the calibration system may also include estimating a third plurality of extrinsic parameters of the camera with respect to the set of markers and with respect to the origin.

Further, the calibration system may include optimizing the first, second, and third plurality of extrinsic parameters. Each plurality of extrinsic parameters may include an error related to re-projections on the set of markers, and the optimization may minimize the error related to re-projections. Also, the optimization may utilize the third plurality of extrinsic parameters. Further, the optimization may minimize differences between overlapping values in the second plurality of extrinsic parameters. The calibration system may also include constraining the optimization by using an additional set of markers at known positions in front of the camera.

Furthermore, the calibration system may include approximating distortion perpendicular to the plane by polynomial approximation.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The surround view system calibration may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows a schematic view of an example simulated predetermined shape related to a view of surroundings of an object hosting a surround view system.

FIG. 2 shows an example set of views of a surround view system that the surround view calibration system can calibrate.

FIG. 3 shows a diagram of example logic for calibrating parameters a surround view system.

FIG. 4 shows an example configuration of a surround view system that the surround view calibration system can calibrate.

### DETAILED DESCRIPTION

In objects, such as vehicles, there is a growing demand for obtaining information, such as a view, on the surroundings of the object. For example, for a vehicle, a driver often desires information beyond sensor information to assist with parking. Also, it is often desired to provide a display of the surroundings, showing both the vehicle and its surroundings from a top view. Such a display usually cannot be obtained from ultrasound sensors as they are often used for sensing and controlling parking distances. Instead, cameras may be used to obtain such a top view. A display of the top view or any other view of the surrounding of the object may be presented on an interactive electronic display within operable distance from a driver of a vehicle, for example. This displayed view then enables the driver to maneuver the vehicle without turning his or her head. Such information might render millimeter precision even in rough terrain, such as off-road passages, avoiding rocks, trees, logs and other obstacles. Such information may also be particularly useful when parking with a trailer. Further, the display may be operable to be perceived by the driver under various lighting conditions. Such information may also be useful for controlling objects remotely.

To obtain a surround view, such as a 360 degree view, of an object's surroundings a surround view system should at least use two cameras. In a case of a surround view system for a vehicle, such cameras may be positioned in side mirrors of the vehicle. A central computer may process data obtained from the cameras. Also, the cameras may be positioned at various locations of a vehicle to detect moving and stationary objects of the surroundings. For example, the cameras may monitor other objects moving perpendicular or parallel with respect to the vehicle. Also, with respect to positioning the cameras, it is beneficial to avoid blind spots in viewing the vehicle's surroundings.

Given at least the abovementioned aspects of a surround view system, an automated calibration system for calibrating the surround view system may be desired. One known approach for calibration includes the Roger Y. Tsai Algorithm. However, this approach similar to other known approaches may perform calibration with respect to markers at fixed positions. For such calibrations, an object hosting a surround view system should also be in a fixed position and orientation. Both aspects of known approaches may be difficult to maintain where the object hosting the surround view system is mobile.

One solution for the above-mentioned difficulty is to provide logic for calibrating the surround view system that does not depend on making fixed measurements. Also referred to as the calibration logic or the logic, a configuration of the logic may include a computer program product, hardware, or a combination thereof. That is, the logic may be configured as a device or computer program product adapted for calibrating a surround view system.

One aspect of the logic may include determining extrinsic parameters of all cameras of the surround view system. Further, in regards to such logic the surround view system may include a plurality of cameras where each camera may include a predetermined intrinsic calibration. The predetermined intrinsic calibration may be utilized in determining the extrinsic parameters.

Regarding the cameras, they may be attached to an object, such as a vehicle, so that they may capture a surround view simulating looking out from or above the object.

The logic may be configured to position a set of markers spaced apart by predetermined dimensions. The positioned markers may be located on a single plane at least partially surrounding the object. The positioned markers may also be in a field of view of at least one of the cameras. The logic may also be configured to calculate extrinsic parameters of at least one of the cameras from a set of the positioned markers for that camera. Further, the logic may be configured to repeat the aforementioned aspects of the logic for each of the other cameras of the surround view system.

A set of markers may be arranged by the logic in various patterns. Such patterns may include a checkerboard pattern, for example. A checkerboard pattern may include the markers in a single plane, such that the markers are coplanar. Further, the check board pattern may be three-dimensional or two-dimensional plane, such as quadratic or flat plane, respectively.

With respect to the predetermined intrinsic calibration, which may be determined by any known method, the logic may determine the extrinsic parameters. Since intrinsic parameters for each camera may be predetermined from the predetermined intrinsic calibration, a basis is provided for determining the extrinsic parameters. The extrinsic parameters may include rotation and translation parameters. Also, since a set of markers may include a number of points greater than a number of unknowns in a system of linear equations (also known as a linear system) used for determining the extrinsic parameters, an instant of the linear system can be sufficient to determine calibration criteria for a surround view system.

Regarding the field of view of each camera, each field of view may at least partially overlap with at least one of its neighboring fields of view. The overlapping of fields of view may be advantageous in that the overlapping may confirm corresponding image points captured with different cameras of the surround view system. Further, markers of a set of markers include dimensions and positions within a plane that may be known to the logic. The combination of the known marker information with the overlap information further contributes to reduction of errors of calibration.

Further, for example, for sets of markers located within one plane, the logic may refer to left and right neighboring markers when referring to the sets of markers for each camera. The logic may also refer to corresponding points between each set of markers. A set of markers may also include an origin, and the extrinsic parameters of a camera may refer to the origin. The origin may be an origin of a global coordinate system.

In addition, the logic may further be configured to calculate a second set of extrinsic parameters for each camera of the surround view system. The calculation of the second set of extrinsic parameters may be with respect to the initial extrinsic parameters of the other cameras of the surround view system. From this additional aspect of the logic, the logic's calibration of the cameras may be done with respect to neighboring cameras. In other words, the extrinsic parameters of a camera may be expressed relative to parameters of its neighbors. Also, similar to the other aspects of the logic, the logic may repeat this aspect for each camera of the surround view system.

With these determinations of the sets of extrinsic parameters, the logic may generate a set of equations for optimization of the calibration. Furthermore, the logic may further be configured to estimate a third set of extrinsic parameters for each of the other cameras relative to the origin. The origin, as a reference point, may provide a reference to express extrinsic parameters of any of the other cameras as viewed from one camera as the origin.

Also, the logic may further be configured to optimize the sets of extrinsic parameters by reducing noise in measurements of the extrinsic parameters. The logic may reduce noise via a least squares approach (described below). Such an approach may include use of the Levenberg-Marquardt algorithm (LMA) (also known as the damped least-squares (DLS) method). The LMA interpolates between the Gauss-Newton algorithm (GNA) and the method of gradient descent.

The logic may also use the third sets of external parameters to derive re-projections, and the optimization or reduction of noise may minimize error in these re-projections. The optimization may also minimize differences between overlapping values in the second sets of parameters for each camera. This may be used as a further constraint to minimize noise. Additionally, the optimization may be constrained by an additional set of markers at predetermined positions in front of each camera. This additional information provides bounds for the noise reduction. Further, the logic may apply a maximum likelihood approach in addition to or instead of a least-square approach.

The logic may also approximate polynomials for distortions perpendicular to the projection plane of a camera. Other approximations may be used as well, such as a spline function.

With respect to the surround view system, a camera of the system may be camera with a fisheye lens. In addition, or alternatively, cameras including a rectilinear lens may be used. Further, the horizontal opening angle of a camera of the system can be equal or greater than 175°. Where this is the case, the camera may then provide a view, at least partially, of a neighboring camera's view, which provides redundancy for calibrating the surround view system.

With regards to configuring the cameras of the surround view system, the cameras may be symmetrically placed with respect to at least one axis of the object hosting the system. Where the object is a vehicle, the cameras may be place in or attached to the left and right mirror of the vehicle. Also, a camera may be positioned at a front portion and/or a rear portion of the vehicle, such as the front end and/or the rear end of the vehicle. For larger objects such as a building or a larger vehicle, such as a truck, ship, boat, train, or aircraft, there may be additional or other positions for cameras chosen, such as near a rim of a roof of the object. The surround view system may include any number of cameras, such as two, four, six, or eight cameras, for example.

In the following, an example surround view system is discussed including four cameras. The number of cameras should by no means be understood as limiting, but merely as being chosen for explanatory purposes, and the number of cameras may vary for different systems and different objects according to an application of the surround view system.

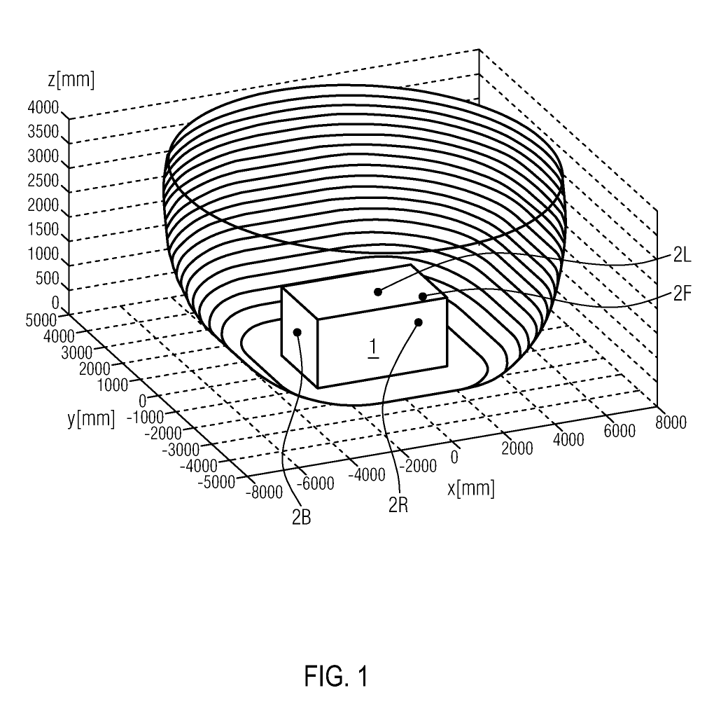

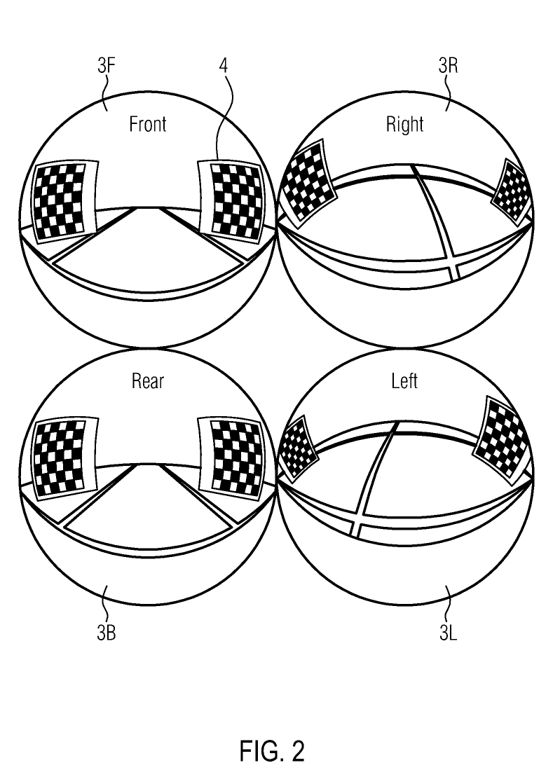

FIG. 1 depicts a schematic view of an example simulated predetermined shape related to a view of surroundings of an object hosting an example surround view system. Depicted is an object 1, with a surround view system including four cameras. The cameras are denoted as 2F, indicating the front camera, 2B, indicating the rear/back camera, 2L, indicating the left camera, and 2R, indicating the right camera. The object 1 is depicted as a rectangular cuboid. The cameras 2F, 2B, 2L, and 2R are depicted as black circles, which are placed symmetrically with respect to a long axis and a short axis of the cuboid representing the object 1. The object 1 may represent a vehicle, for example. In FIG. 1, the cameras 2F, 2B, 2L, and 2R are positioned such that they are at a same height or position with respect to a z-axis. The z-axis represents a vertical axis in FIG. 1. FIG. 1 also depicts an x-axis in units of millimeters from −8000 mm to 8000 mm, and a y-axis from −5000 mm to 5000 mm, respectively. The z-axis shows in units of millimeters a range from 0 to 4000 mm. These ranges are merely given for illustrative purposes.

The cameras 2F, 2B, 2L, and 2R of the example surround view system have a large opening angle such as extra wide angle. The opening angle of these cameras 2F, 2B, 2L, and 2R, may be greater than 120°. The horizontal opening angle of these cameras may be equal or greater to 175°. The cameras may alternatively be positioned symmetrically with respect to the perimeter of the object 1, to cover, as much as possible, surroundings of the object. Due to constructional aspects of the object 1, for example of a vehicle, it may be more cumbersome to provide these cameras at the side of the object 1 to view the side directions. The cameras 2F, 2B, 2L, and 2R may therefore be provided at the outmost left and right points of the object 1, such as mirrors of a vehicle (not shown) to provide a sufficient view and coverage of the side surroundings of the object 1.

As mentioned, a simulated predetermined shape, e.g., a simulated bowl, is depicted in FIG. 1. The simulated predetermined shape can have a flat bottom with a rectangular shape and a rim with a parabolic shape, for example. This shape can represent a projection space of the cameras 2F, 2B, 2L, and 2R. Also, referred to as the bowl-shaped projection surface, the bottom of the bowl-shaped projection surface of the object 1 is flat such that points on the bottom may form a flat plane. The simulated predetermined shape may also represent a surround view rendered by system logic of the surround view system, and the surround view may take the form of other simulated shapes, such as a sphere, a cylinder, a cuboid, a cone, a pyramid, a series of arcs, or any other predetermined simulated shape capable of providing a surround view. The system logic, which may be responsible for the processing and generation of the surround view, may also include the calibration logic.

FIG. 2 shows an example of a checkerboard test pattern 4 as viewed by four cameras (e.g., cameras with fisheye lenses), where the views with these cameras are denoted as 3F (front), 3B (rear/back), 3L (left), and 3R (right). The cameras producing the views of FIG. 2 may correspond to the cameras 2F, 2B, 2L, and 2R as shown in FIG. 1, respectively. Each of the cameras of FIG. 2 show, for example, a checkerboard test pattern that may be in view of at least two of the cameras.

Referring back to the cameras of FIG. 1, for example, the cameras 2F (front) and 2R (right) may view test boards, such as the checkerboard test pattern 4 as shown in FIG. 2, in view 3F and 3R. That is, at least two cameras may view the checkerboard test pattern 4.

Regarding the logic for calibrating a surround view system, the following description of the logic, is an example configuration of the logic for calibrating a system with four cameras, such as the example system including the four cameras of FIG. 1. Given this, the logic is not limited to systems using four cameras, but can be applicable to systems having any number of cameras. The following description of logic is for illustrative purposes.

For example, assuming that intrinsic calibration for each camera 2F, 2B, 2L, and 2R of the surround view system of FIG. 1 is predetermined and has been achieved by a known calibration method, the logic's determination of extrinsic parameters may be decoupled from the calibration of intrinsic parameters. The extrinsic parameters, which may be rotational and translational parameters, may be derivable from a plane providing a set of test markers, such as the checkerboard test patterns shown in FIG. 2, for which dimensions of the patterns may be known. For example, the outer dimensions (perimeter) of the set of test markers may be known and the distance between test markers may be known. The test markers may be located in a flat plane or a parabolic plane, for example. For the checkerboard test pattern 4, its dimensions may be known and the dimensions of the black and white squares or rectangles of the board may be known.

The cameras 2F, 2B, 2L, and 2R of FIG. 1, which may be cameras with a fisheye lens, include different mapping mechanisms. A specific camera response function describing the camera behavior of each camera may be difficult to obtain. Therefore, distortions may be approximated by approximation functions such a polynomials or splines.

In the following, a translation matrix T describes extrinsic parameters for the translation of a pattern/set of markers for the camera. A rotational matrix R describes rotational extrinsic parameters such as Euler angles, for example.

Throughout the following description, a notation for vectors with a plurality of components may be denoted as [x,y,z]. A transposed vector is denoted as [x,y,z]′ or [x,y,z]T. In an external pattern coordinate system, a point is described as X=[X,Y,Z,1]′. A projection of the point X=[X,Y,Z,1]′ as view by one of the cameras is described as x=[x,y,z]′.

As mentioned above, the logic may approximate the distortion of a camera, such as distortion perpendicular to a projection plane. The approximation is represented by a variable z below. The logic may determine z by polynomial approximation.

z=a₀+a₁d+a₂d² . . . +aₙdⁿ

In the above approximation, d denotes distance of a projected point with respect to an image center, and n denotes the degree of a polynomial chosen for the approximation.

In the following, H denotes a projection matrix, for which a cross product of H and x is zero because H and x are collinear. The projection matrix H is defined below.

$$H = [ \begin{matrix}{R}_{11} , & {R}_{12} , & {R}_{13} , & {T}_{1} \\ {R}_{21} , & {R}_{22} , & {R}_{22} , & {T}_{2} \\ {R}_{31} , & {R}_{32} , & {R}_{33} , & {T}_{3} \\ 0 & 0 & 0 & 1\end{matrix} ] \qquad ( 1 )$$

For the following determinations, the logic may assume that Z=0, and a point is located on an X-Y plane of the external pattern coordinate system. Under this assumption, the logic may obtain the following equation.

$$[ \begin{matrix}x \\ y \\ z\end{matrix} ] \times [ \begin{matrix}{R}_{11} , & {R}_{12} , & {T}_{1} \\ {R}_{21} , & {R}_{22} , & {T}_{2} \\ {R}_{31} , & {R}_{32} , & {T}_{3}\end{matrix} ] [ \begin{matrix}X \\ Y \\ 1\end{matrix} ] = 0 \qquad ( 2 )$$

From equation (2), the logic may derive the following linear system, taking into account the approximation of z.

yᵢ(R₃₁Xᵢ+R₃₂Y+T₃)−(a₀+ . . . +aₙdⁿ)(R₂₁Xᵢ+R₂₂Yᵢ+T₂)=0

(a₀+ . . . +aₙdⁿ)(R₁₁Xᵢ+R₁₂Yᵢ+T₁)−xᵢ(R₃₁Xᵢ+R₃₂Yᵢ+T₃)=0

xᵢ(R₂₁Xᵢ+R₂₂Yᵢ+T₂)−yᵢ(R₁₁Xᵢ+R₁₂Yᵢ+T₁)=0 (3)

The logic may only use the last two equations for points located on a test board/pattern, from which the logic may obtain the following equation.

L·M=0 (4)

The logic defines M and L as shown below.

M=[R₁₁,R₁₂,R₂₁,R₂₂,T₁,T₂]′ and

$$L = [ \begin{matrix}- {y}_{1} {X}_{1} , & - {x}_{1} {Y}_{1} , {x}_{1} {X}_{1} , {y}_{1} {Y}_{1} , & - {x}_{1} , {y}_{1} \\ - {y}_{2} {X}_{2} , & - {x}_{2} {Y}_{2} , {x}_{2} {X}_{2} , {y}_{2} {Y}_{2} , & - {x}_{2} , {y}_{2} \\ - {y}_{3} {X}_{3} , & - {x}_{3} {Y}_{3} , {x}_{3} {X}_{3} , {y}_{3} {Y}_{3} , & - {x}_{3} , {y}_{3}\end{matrix} ] \qquad ( 5 )$$

Since the number of points from a set of markers, such as the checkerboard test pattern 4, is usually greater than the number of unknowns, the logic may solve the linear system by least square criteria, such as

min|L·M| with respect to |M|²=1.

Furthermore, the columns of the rotational matrix R may be orthonormal. Therefore, the remaining components of the rotational matrix R may be uniquely determined by the logic.

The logic also may determine the extrinsic rotational and translational parameters with the exception of T3.

To determine T3, the logic uses the first two equations of (3), taking into account the expressions obtained above for the rotational and translational parameters, R and T. Given this, the logic may use the following equations.

$$\begin{matrix}[ \begin{matrix}{A}_{1} , {A}_{1} {d}_{1} … {A}_{1} {d}_{1 , 1}^{n} \\ {C}_{1} , {C}_{1} {d}_{1} … {C}_{1} {d}_{1}^{n} \\ … \\ {A}_{k} , {A}_{k} {d}_{k} … {A}_{k} {d}_{k}^{n} \\ {C}_{k} , {C}_{1} {d}_{k} … {C}_{1} {d}_{k}^{n}\end{matrix} ] \cdot [ \begin{matrix}{a}_{0} \\ … \\ {a}_{N}\end{matrix} ] - {T}_{3} [ \begin{matrix}{y}_{1} \\ {x}_{1} \\ … \\ {y}_{N} \\ {x}_{N}\end{matrix} ] = [ \begin{matrix}{B}_{1} \\ {D}_{1} \\ … \\ {B}_{k} \\ {D}_{k}\end{matrix} ] & ( 6 ) \\ {A}_{j} = {R}_{21} {X}_{j} + {R}_{22} {Y}_{j} \\ {B}_{j} = {y}_{j} ( {R}_{31} {X}_{j} + {R}_{32} {Y}_{j} ) \\ {C}_{j} = {R}_{11} {X}_{j} + {R}_{12} {Y}_{j} + {T}_{1} \\ {D}_{j} = {x}_{j} ( {R}_{31} {X}_{j} + {R}_{i , 32} {X}_{j} ) & ( 7 )\end{matrix}$$

The index j denotes a point on the test board, such as a marker of a test set of markers.

Using the equation (6), the logic obtains the overdetermined linear system. The logic may obtain this overdetermined linear by using the Moore-Penrose pseudoinverse (also referred to as pseudoinverse) to compute a best fit (such as least squares) solution to a system of linear equations. This last determination may also serve as a minimum (Euclidean) norm solution of a system of linear equations with multiple solutions. The pseudoinverse may be defined and unique for all matrices whose entries are real or complex numbers, and may be implemented using singular value decomposition (SVD).

Given this, the logic may solve for T3 via the following equation.

$${T}_{3} = ( [ \begin{matrix}{A}_{1} , {A}_{1} {d}_{1} … {A}_{1} {d}_{1 , 1}^{n} \\ {C}_{1} , {C}_{1} {d}_{1} … {C}_{1} {d}_{1}^{n} \\ … \\ {A}_{k} , {A}_{k} {d}_{k} … {A}_{k} {d}_{k}^{n} \\ {C}_{k} , {C}_{1} {d}_{k} … {C}_{1} {d}_{k}^{n}\end{matrix} ] \cdot [ \begin{matrix}{a}_{0} \\ … \\ {a}_{N}\end{matrix} ] - [ \begin{matrix}{B}_{1} \\ {D}_{1} \\ … \\ {B}_{k} \\ {D}_{k}\end{matrix} ] ) \cdot pseudonverse ( [ \begin{matrix}{y}_{1} \\ {x}_{1} \\ … \\ {y}_{N} \\ {x}_{N}\end{matrix} ] ) \qquad ( 8 )$$

This above equation may also serve as a basis from which the logic determines the parameters of the rotational and translational matrices, R and T. For example, the logic may use the above equation to determine the external parameters of the cameras of FIG. 1 for each particular test board of FIG. 2.

Given the above determinations, the logic may also obtain the extrinsic parameters of a second camera, relative to the extrinsic parameters of a first camera. For example, the first camera may be the front camera and the second camera is the right camera, as shown in FIGS. 1 and 2. RBoard1L and RBoard1R represent left and right rotation matrices of a test board/pattern relative to the first camera. The corresponding translational parameters are denoted as TBoard1L and TBoard1R, respectively. The logic may express the second camera in its position relative to the first camera. Equations describing the aforementioned relationships are denoted below.

R₁Camera₂=RBoard_{1R}*RBoard_{1L}⁻¹=RBoard_{1R}*RBoard_{1L}^{T} (9)

T₁Camera₂=TBoard_{1R}−R₁Camera₂*TBoard_{2L}

Given the above scheme, the parameters of the second camera may be expressed relative to the first camera. Further, a third camera, such as the back camera in FIG. 1, may be expressed relative to the second camera. Further, a fourth camera depicted in FIG. 1 as the left side camera, may be expressed relative to the first camera, for example.

The logic may also determine the extrinsic parameters of third camera (rear) relative to first camera in two different ways, for example. The logic may use the parameters of the second camera as an intermediate result or the logic may use the parameters of the fourth camera as an intermediate result. These two options may be expressed by the following sets of equations.

R₁Camera₃=R₁Camera₂*R₂Camera₃

T₁Camera₃=R₂Camera₃*T₂Camera₃+T₁Camera₂ (10)

R₁Camera₃=R₁Camera₄*R₄Camera₃

T₁Camera₃=R₄Camera₃*T₄Camera₃+T₁Camera₄ (11)

For obtaining an overall reference point, the logic may determine the extrinsic parameters of the first camera (the front camera) by interacting with the set of test markers positioned on the ground in front of the camera. Further, the position of the calibration board/test markers may include a long axis of the board coinciding with a middle portion of a front end of a vehicle, for example. This position of the board may be a starting point for the calibration of a camera of the surround view system. Further, the long axis of the board may be parallel to a long axis of the vehicle, for example. The dimensions of the set of test markers/board may be predetermined or known and may be used as input for the logic. The extrinsic parameters for the first camera may be obtained with respect to an overall reference point.

The logic may also determine the extrinsic parameters of the remaining three cameras of the above example (the third camera or the rear camera, the fourth camera or the left camera, and the second camera or the right camera) relative to the origin, which is relative to the reference point. This determination is denoted by the following equations.

RCamera₂Orig=RCamera₁Orig*R₁Camera₂

T₁Camera₂Orig=RCam₁Orig*T₁Camera₂Orig+TCam₁Orig

RCamera₃Orig=RCamera₁Orig*R₁Camera₃

T₁Camera₃Orig=RCam₁Orig*T₁Camera₃Orig+TCam₁Orig

RCamera₄Orig=RCamera₁Orig*R₁Camera₄

T₁Camera₄Orig=RCam₁Orig*T₁Camera₄Orig+TCam₁Orig

The above equations represent a model of the extrinsic parameters for four cameras, e.g., the four cameras of FIG. 1. However, this model as represented by the above equations does not consider noise or distortions. Therefore, the measurements obtained from the cameras may be input for optimization logic that may reduce noise and distortion.

The optimization logic may include a least squares approach, such as a mean least squares method. For example, the Levenberg-Marquardt may be included.

Within the optimization logic, further constraints may be taken into consideration. For example, re-projections of the calibration boards may be utilized. Further, the parameters determined by equations (10) and (11) may yield similar results. Additional boards located in front of each camera, usually on the ground, may also be used by the optimization logic.

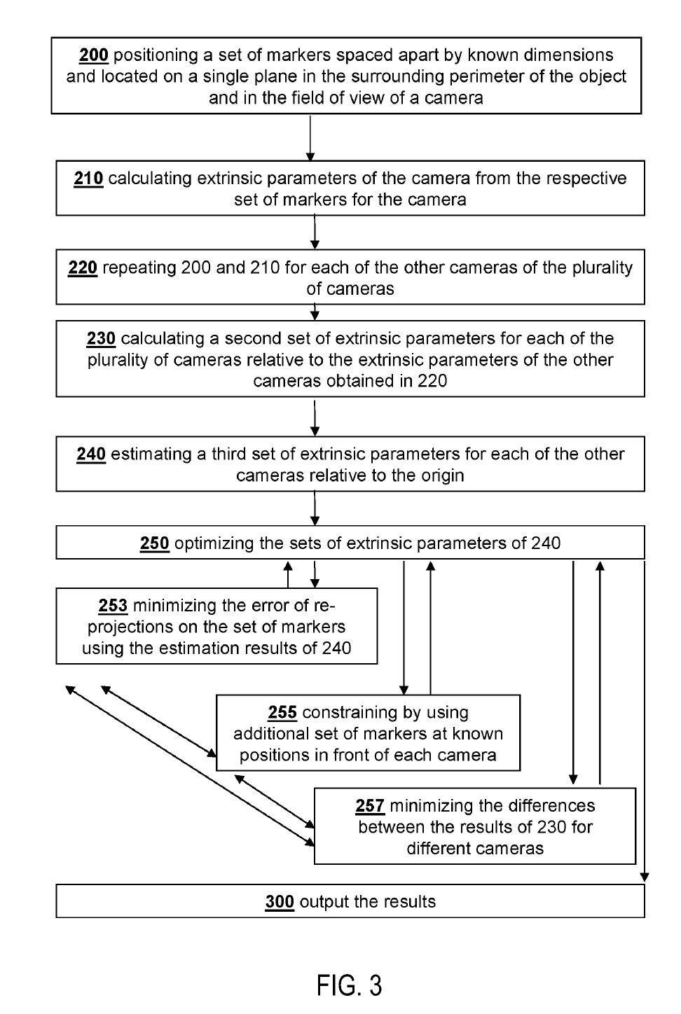

FIG. 3 shows an example of the logic mentioned above. The logic may be configured to position a set of markers spaced apart by known dimensions and located on a single plane at least partially surrounding an object, for example, and in a field of view of a camera of a surround view system that may be a part of the object (200). The logic may also determine extrinsic parameters of the camera from the set of markers (210). These last two steps may be repeated by the logic for each camera of the surround view system (220). The logic may also determine a second set of extrinsic parameters for each camera of the surround view system relative to the extrinsic parameters of the other cameras of the surround view system (230). The logic may also estimate a third set of extrinsic parameters for each of the other cameras of the surround view system relative to an origin, such as an origin of a global coordinate system (240). The logic can also optimize the first, second, or third set of extrinsic parameters (250). The optimization may take into account one or more of: minimizing an error related to re-projections on the set of markers using the estimation results of 240 (253); constraining by using an additional set of markers at known positions in front of each camera (255); and minimizing the differences between the results of 230 for different cameras (257). Upon one or more of the above determinations, the logic may output results of the determination(s) (300).

As explained in detail below, the logic may be configured in a control unit that may be a part of computer software, hardware, firmware, or a combination thereof. The logic or parts of the logic may be stored on at least one computer readable medium such as a hard disk, a flash disk, a flash memory or any other memory unit. The memory unit may include computer-executable instructions for performing aspects of the logic when executed on a computing device or computer such as the control unit. These computer-executable instructions may, for example, be coded in an object-oriented computer language such as C++.

Data obtained from a surround view system may be processed by a control unit of an object hosting the surround view system. The control unit may provide an image of the data on a display, visible to a driver of a vehicle, for example. The results obtained may also be combined with speed control systems controlling the speed of a vehicle, for example. Predetermined thresholds regarding one or more of visibility, speed, vicinity of objects, change of speed of nearby objects may be taken into account and may be signaled to a driver in control of a vehicle, for example.

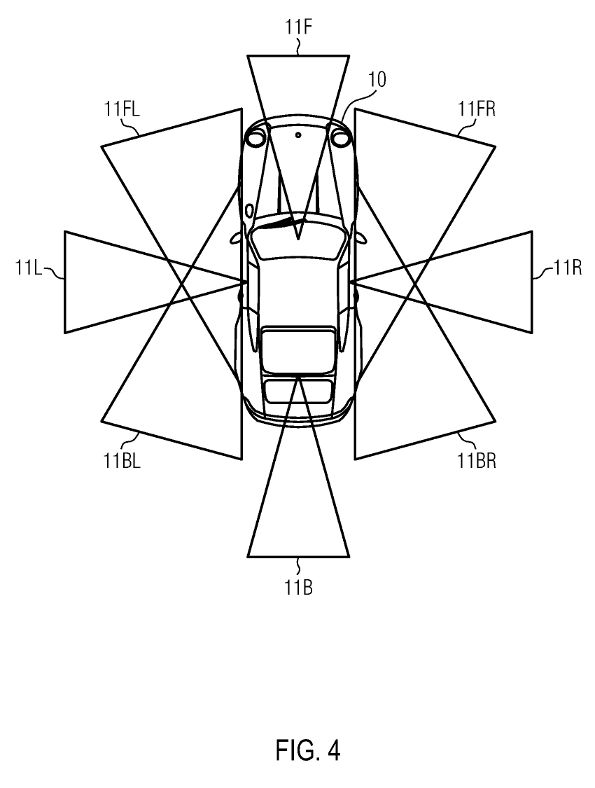

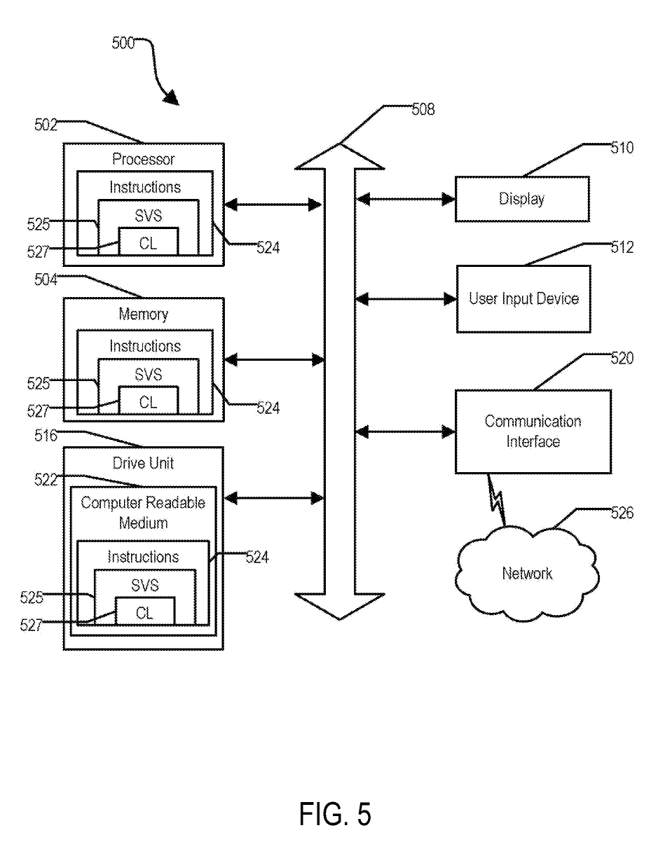

FIG. 4 shows a further example where the object is an example car 10. The car 10 is equipped with a surround view system with six cameras, 11F, viewing front surroundings, 11B, viewing rear/back surroundings, 11R, viewing right surroundings, 11L, viewing left surroundings, 11FL viewing front left surroundings, 11FR, viewing front right surroundings, 11BL, viewing rear left surroundings, and 11BR, viewing rear surroundings. The cameras 11F, 11B, 11L, 11R, 11FL, 11FR, 11BL and 11BR may cover an entire surrounding perimeter of the car 10. Also, at least one of the cameras may view another camera of the surround view system. Similar to the surround view system shown in FIGS. 1 and 2, these cameras have overlapping fields of view.

The data obtained from the surround view system may be obtained by pattern recognition units capable of comparing the obtained data with predetermined patterns such as the silhouette of a person, an animal or, in addition, the silhouette of heat radiating sources. This may be beneficial for providing sufficient vision at night to safely guide the object, especially when that object is a vehicle. Further, the cameras may view surroundings via light or heat sensing technologies. The cameras may also register traffic information such as road signs, traffic lights, or warning signs. The cameras may even register such traffic information that may not be in a field of view of a driver of a vehicle.

Furthermore, the object (such as a vehicle), the cameras, the calibration logic, or any other component of the surround view system may be or may include a portion or all of one or more computing devices of various kinds, such as the computer system 500 in FIG. 5. The computer system 500 may include a set of instructions that can be executed to cause the computer system 500 to perform any one or more of the methods or computer based functions disclosed. The computer system 500 may operate as a standalone device or may be connected, e.g., using a network, to other computer systems or peripheral devices.

In a networked deployment, the computer system 500 may operate in the capacity of a server or as a client user computer in a server-client user network environment, as a peer computer system in a peer-to-peer (or distributed) network environment, or in various other ways. The computer system 500 can also be implemented as or incorporated into various devices, such as various types of vehicle computer systems (e.g., Electronic/Engine Control Module, Powertrain Control Module, Transmission Control Module, Brake Control Module), a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. The computer system 500 may be implemented using electronic devices that provide voice, audio, video or data communication. While a single computer system 500 is illustrated, the term “system” may include any collection of systems or sub-systems that individually or jointly execute a set, or multiple sets, of instructions to perform one or more computer functions.

The computer system 500 may include a processor 502, such as a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually or programmed.

The term “module” may be defined to include a number of executable modules. The modules may include software, hardware or some combination thereof executable by a processor, such as processor 502. Software modules may include instructions stored in memory, such as memory 504, or another memory device, that may be executable by the processor 502 or other processor. Hardware modules may include various devices, components, circuits, gates, circuit boards, and the like that are executable, directed, and/or controlled for performance by the processor 502.

The computer system 500 may include a memory 504, such as a memory 504 that can communicate via a bus 508. The memory 504 may be a main memory, a static memory, or a dynamic memory. The memory 504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 504 includes a cache or random access memory for the processor 502. In alternative examples, the memory 504 may be separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described may be performed by the programmed processor 502 executing the instructions stored in the memory 504. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

A computer readable medium or machine readable medium may include any non-transitory memory device that includes or stores software for use by or in connection with an instruction executable system, apparatus, or device. The machine readable medium may be an electronic, magnetic, optical, electromagnetic, infrared, or semiconductor system, apparatus, or device. Examples may include a portable magnetic or optical disk, a volatile memory such as Random Access Memory “RAM”, a read-only memory “ROM”, or an Erasable Programmable Read-Only Memory “EPROM” or Flash memory. A machine readable memory may also include a non-transitory tangible medium upon which software is stored. The software may be electronically stored as an image or in another format (such as through an optical scan), then compiled, or interpreted or otherwise processed.

The computer system 500 may or may not further include a display unit 510, such as a liquid crystal display (LCD), an organic light emitting diode (OLED), a flat panel display, a solid state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 516.

The computer system 500 may include an input device 512 configured to allow a user to interact with any of the components of system 500. The input device 512 may be a number pad, a keyboard, or a cursor control device, such as a mouse, or a joystick, touch screen display, remote control or any other device operative to interact with the computer system 500. A user of the navigation system 100 may, for example, input criteria or conditions to be considered by the navigation device 102 in calculating a route using the input device 512.

The computer system 500 may include a disk or optical drive unit 516. The disk drive unit 516 may include a computer-readable medium 522 in which one or more sets of instructions 524 or software can be embedded. The instructions 524 may embody one or more of the methods or logic described herein, such as calibration logic 527 of a surround view system 525. The instructions 524 may reside completely, or partially, within the memory 504 and/or within the processor 502 during execution by the computer system 500. The memory 504 and the processor 502 also may include computer-readable media as discussed above.

The computer system 500 may include computer-readable medium that includes instructions 524 or receives and executes instructions 524 responsive to a propagated signal so that a device connected to a network 526 can communicate voice, video, audio, images or any other data over the network 526. The instructions 524 may be transmitted or received over the network 526 via a communication port or interface 520, and/or using a bus 508. The communication port or interface 520 may be a part of the processor 502 or may be a separate component. The communication port 520 may be created in software or may be a physical connection in hardware. The communication port 520 may be configured to connect with a network 526, external media, the display 510, or any other components in system 500, or combinations thereof. The connection with the network 526 may be a physical connection, such as a wired Ethernet connection or may be established wirelessly as discussed later. The additional connections with other components of the system 500 may be physical connections or may be established wirelessly. The network 526 may alternatively be directly connected to the bus 508.

The network 526 may include wired networks, wireless networks, Ethernet AVB networks, or combinations thereof. The wireless network may be a cellular telephone network, an 802.11, 802.16, 802.20, 802.1Q or WiMax network. Further, the network 526 may be a public network, such as the Internet, a private network, such as an intranet, or combinations thereof, and may utilize a variety of networking protocols now available or later developed including, but not limited to TCP/IP based networking protocols. One or more components of the navigation system 100 may communicate with each other by or through the network 526.

The term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed. The “computer-readable medium” may be non-transitory, and may be tangible.

The computer-readable medium may include a solid-state memory such as a memory card or other package that houses one or more non-volatile read-only memories. The computer-readable medium may be a random access memory or other volatile re-writable memory. The computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. The computer system 500 may include any one or more of a computer-readable medium or a distribution medium and other equivalents and successor media, in which data or instructions may be stored.

In alternative examples, dedicated hardware implementations, such as application specific integrated circuits, programmable logic arrays and other hardware devices, may be constructed to implement various parts of the system. Applications that may include the apparatus and systems can broadly include a variety of electronic and computer systems. One or more examples described may implement functions using two or more specific interconnected hardware modules or devices with related control and data signals that can be communicated between and through the modules, or as portions of an application-specific integrated circuit. The computer system 500 encompasses software, firmware, and hardware implementations.

The system described may be implemented by software programs executable by a computer system. Implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Replacement standards and protocols having the same or similar functions as those disclosed may also or alternatively be used.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. Logic for calibrating a surround view system of an object, configured to:
position a set of markers on a plane at least partially surrounding the object, where the plane is in a field of view of a camera, where the camera comprises a predetermined intrinsic calibration, and where the camera is part of the surround view system;
determine a first plurality of extrinsic parameters of the camera with respect to the set of markers, where the set of markers comprises an origin and the first plurality of extrinsic parameters includes a reference to the origin; and
repeat the positioning of the set of markers and the determination of the first plurality of extrinsic parameters for at least one other camera of the surround view system.

2. The logic according to claim 1, where the object is a vehicle.

3. The logic according to claim 1, where the field of view of the camera at least partially overlaps the field of view of another camera of the surround view system.

4. The logic according to claim 3, where logic is further configured to:
select markers in an overlapping region of the field of views of a plurality of the cameras of the surround view system.

5. The logic according to claim 1, where logic is further configured to:
determine a second plurality of extrinsic parameters of the camera with respect to the set of markers and with respect to the first plurality of extrinsic parameters of the at least one other camera of the surround view system.

6. The logic according to claim 5, where logic is further configured to:
estimate a third plurality of extrinsic parameters of the camera with respect to the set of markers and with respect to the origin.

7. The logic according to claim 6, where logic is further configured to:
optimize the first, second, and third plurality of extrinsic parameters.

8. The logic according to claim 7, where each plurality of extrinsic parameters includes an error related to re-projections on the set of markers, and where the optimization minimizes the error related to re-projections.

9. The logic according to claim 7, where the optimization utilizes the third plurality of extrinsic parameters.

10. The logic according to claim 7, where the optimization minimizes differences between overlapping values in the second plurality of extrinsic parameters.

11. The logic according to claim 7, where logic is further configured to:
constrain the optimization by using an additional set of markers at known positions in front of the camera.

12. The logic according to claim 1, where logic is further configured to:
approximate distortion perpendicular to the plane by polynomial approximation.

13. A surround view system, comprising:
a plurality of cameras;
a control unit linking the cameras to calibration logic; and
where the calibration logic is configured to:
position a set of markers on a plane at least partially surrounding an object, where the plane is in a field of view of a camera of the plurality of cameras, and where the camera comprises a predetermined intrinsic calibration;
determine a first plurality of extrinsic parameters of the camera with respect to the set of markers, where the set of markers comprises an origin and the first plurality of extrinsic parameters includes a reference to the origin; and
repeat the positioning of the set of markers and the determination of the first plurality of extrinsic parameters for at least one other camera of the plurality of cameras.

14. The surround view system according to claim 13, where each camera of the plurality of cameras comprises a fisheye lens.

15. The surround view system according to claim 13, where the plurality of cameras is positioned symmetrically with respect to at least one axis of the object.

16. The surround view system according to claim 13, where the surround view system comprises four cameras.

17. A method comprising:
positioning a set of markers on a plane, where the plane at least partially surrounds an object, where the plane is in a field of view of a camera that is part of a surround view system hosted by the object, and where the camera comprises a predetermined intrinsic calibration;
determining a first plurality of extrinsic parameters of the camera with respect to the set of markers, where the set of markers comprises an origin and the first plurality of extrinsic parameters includes a reference to the origin; and
repeating the positioning a set of markers and the determining a first plurality of extrinsic parameters for at least one other camera of the surround view system.

18. The method of claim 17, further comprising:
determining a second plurality of extrinsic parameters of the camera with respect to the set of markers and relative to the first plurality of extrinsic parameters of the at least one other camera of the surround view system.

19. The method of claim 17, further comprising:
estimating a third plurality of extrinsic parameters of the camera with respect to the set of markers, and relative to the origin.

20. The method of claim 17, further comprising:
optimizing the first, second, and third plurality of extrinsic parameters.
